(19) United States
(12) Patent Application Publication
(10) Pub. No.: US 2013/0276546 A1
(43) Pub. Date: Oct. 24, 2013

(54) METHOD FOR NON-DESTRUCTIVE QUANTITATIVE DETERMINATION OF THE INTERNAL MICROSTRESS OF TYPE II AND/OR TYPE III

(71) Applicants: Iris Altpeter, Saarbrucken (DE); Klaus Szielasko, Dudweiler (DE); Madalina Rabung, Saarbrucken (DE); Siegfried Schmauder, Lenningen (DE); Peter Binkele, Aidlingen (DE)

(72) Inventors: Iris Altpeter, Saarbrucken (DE); Klaus Szielasko, Dudweiler (DE); Madalina Rabung, Saarbrucken (DE); Siegfried Schmauder, Lenningen (DE); Peter Binkele, Aidlingen (DE)

(21) Appl. No.: 13/848,077

(22) Filed: Mar. 21, 2013

(30) Foreign Application Priority Data
Apr. 3, 2012 (DE) 10 2012 007 062.4

(51) Int. Cl. G01N 3/08; G01N 3/00

(52) U.S. Cl. CPC G01N 3/08; G01N 3/00
USPC 73/826; 73/788

(57) ABSTRACT

The present invention relates to methods for non-destructive quantitative determination of the internal microstresses of type II and/or III which are based on subtraction of the maximum values of the load stress dependency of the maximum Barkhausen noise amplitudes on a test piece before and after hardening of the test piece in specific thermal hardening states. The present invention hence enables independent determination of the internal microstress of type II or III, simultaneous and resolved determination of the internal microstresses of type II and III and also determination of the sum of both types of internal microstresses.

### CLAIM OF PRIORITY

This application claims the benefit of priority of German Patent Application Serial No. 10 2012 007 062.4, entitled “VERFAHREN ZUR ZERSTORUNGSFREIEN QUANTITATIVEN BESTIMMUNG DER MIKROEIGENSPANNUNG II. UND/ODER III. ART,” filed on Apr. 3, 2012, the benefit of priority of which is claimed hereby, and which is incorporated by reference herein in its entirety.

### BRIEF DESCRIPTION OF THE DRAWINGS

FIG. 1 illustrates the hysteresis of a sample, which consists of small steps.

FIG. 2 shows a Barkhausen noise profile curve.

FIG. 3 shows the maximum load stress dependency of the maximum Barkhausen noise amplitude as a function oftensile load stresses.

FIG. 4 illustrates a phase diagram for Fe—Cu alloys.

FIG. 5 shows the maximum Barkhausen noise amplitude of a Fe—Cu—Ni alloy in the initial state and in the finally hardened state.

FIG. 6 shows the progression of the internal micro stress values derived from the maximum Barkhausen noise amplitude as a function of the hardening duration.

FIG. 7 shows the dependency of the internal microstress values as function of the nickel content.

The present invention relates to methods for non-destructive quantitative determination of the internal microstresses of type II and/or III which are based on subtraction of the maximum values of the load stress dependency of the maximum Barkhausen noise amplitudes on a test piece before and after hardening of the test piece in specific thermal hardening states. The present invention hence enables independent determination of the internal microstress of type II or III, simultaneous and resolved determination of the internal microstresses of type II and III and also determination of the sum of both types of internal microstresses.

Nanoscale, coherent precipitations play a dominant role in material hardening. Material hardening is based on the mechanisms of precipitation hardening which is based on preventing the dislocations due to finely distributed, coherent precipitations of secondary phases. It was detected that, in the case of the Fe—Cu system, the coherent Cu precipitations (less than 4 nm diameter) are cut by dislocations since, because of the mechanical-elastic properties, it is more favourable with respect to energy for a part of a dislocation line to be situated inside the precipitation than outside. These coherent precipitations are surrounded by internal microstresses which are inter alia a measure of the existence of such precipitations. At present, there is no non-destructive measuring method worldwide for determining internal microstresses of type II and III for the Fe—Cu and Fe—Cu—(Ni—Mn) systems.

There is understood, in the material-scientific context by internal stresses, the presence of stresses in the interior of a solid body without external forces or moments acting on it.

Basically, internal stresses are subdivided into internal macro- and microstresses. The internal macrostresses, also termed internal stresses of type I, are distinguished by being almost homogeneous over a fairly large number of crystallites. The internal microstresses are subdivided into internal stresses of type II which are homogeneous in microscopic regions and internal stresses of type III which are variable even over a few interatomic distances. In the real case, a superimposition of internal stresses of type I, II and III must be taken into account. Production of internal stresses can have various causes. During cooling, thermal internal stresses of type I are formed for example as a consequence of temperature gradients between the external and internal material regions. The edge cools initially faster than the core, which leads to formation of tensile stresses in the edge region and compressive stresses in the core. If the cooling is sufficiently rapid, the value of the tensile stresses can become so great that they are partially reduced in the edge region by plastic deformation. The compressive stresses in the core are however maintained extensively because of the hardening in the edge region. With equalisation of the temperature gradient, the result is therefore a stress reversal. After complete cooling, compressive stresses therefore remain in the edge region and tensile stresses in the core.

In materials with a heterogeneous structural constitution, thermally induced internal stresses of type II are produced because of the different heat expansion coefficients of the individual structural components. They are also produced with very slow cooling rates. A theoretical estimation for the two-phase material is possible as follows:

σ_{therm·II}=ρ·(α₂−α₂)·ΔT

(with thermally induced internal stress of type II σ_{therm·II} material-specific constant ρ, thermal expansion coefficient α₁ and temperature difference ΔT)

The change in the lattice parameters due to stress relief of the matrix during precipitation of a second phase leads to a change in volume in the matrix. The volume taken up by the second phase is generally not equal to the change in volume of the matrix, which leads to the production of so-called precipitation internal stresses. In the case of coherent precipitations, in addition also coherency internal stresses of type III are produced by the elastic lattice distortions at the interfaces between precipitations and matrix.

As a function of the manner in which an external load and the internal stress state are superimposed, the mechanical behaviour of components can be influenced both positively and negatively. The long-term strength of components can be influenced positively for example by introducing internal compressive stresses in the edge region (e.g. by sand blasting). On the other hand, for example thermally induced internal stresses can lead in welding seams to premature component failure. Estimation of the influence of the internal stress state is generally very difficult since characterisation thereof in reality is very complicated.

In particular in the case of superimposition with external load stresses, the result can be formation of multiaxial stress states and, associated therewith, negative effects. For example so-called stress corrosion cracking could be mentioned here as key word. The internal stresses in a component can normally be greatly reduced by a suitable heat treatment.

Reference methods for quantitative determination of internal microstresses are transmission electron microscopy, X-ray diffractometry and neutron diffractometry. These methods are however very time-consuming, expensive and place particular demands on the sample geometry, which greatly restricts their economic use.

I. Altpeter et al., in “Micro-magnetic evaluation of micro residual stresses of the IInd and IIIrd order”, NDT&E International 42 (2009), 283-290, describe methods for determining internal microstresses of type II or III. In the case of the method approach described there, the internal microstresses of type II and III could not however be separated from each other.

For Fe- and Cu-containing alloy systems, in particular Fe—Cu and Fe—Cu—(—(Ni—Mn), there is at present no non-destructive measuring method for determining internal stresses of type II and III, in particular no measuring method which enables both quantitative determination of the internal microstress of type II and simultaneously type III. It is therefore the object of the present invention to indicate measuring methods with which microstresses of type II and III can be determined, in a simple manner, in iron- and copper-containing alloy systems.

This object is achieved with a method for non-destructive quantitative determination of the internal microstress of type II and simultaneously type III (thermally induced internal stress of type II) having the features of patent claim 1. In addition, the method enables determination of the sum of both types of internal microstresses. Patent claim 8 indicates a method for non-destructive quantitative determination of the internal microstress of type II whilst patent claim 12 describes a method for quantitative determination of the internal microstress of type III. The dependent patent claims represent advantageous developments.

In a first embodiment, the present invention relates to a method for non-destructive quantitative determination of the internal microstress of type III (coherency tensile internal stress of type III, σ_{coh·III}) and of type II (thermally induced internal stress of type II, σ_{therm·II}) and/or of the sum of the internal microstresses of type II and III (Δσ=σ_{therm·II}+σ_{coh·III}) of an Fe- and Cu-containing alloy system with a Cu content of ≦2% by weight, comprising the following steps:
a) determination of the load stress value σ₁ at which the load stress dependency of the maximum Barkhausen noise amplitude M_{MAX}(σ) for a test piece made of the alloy system in an initial state (i.e. in a state before thermal hardening) has a maximum,
b) first hardening of the test piece up to exclusive formation of coherent precipitations,
c) determination of the load stress value σ₂ at which the load stress dependency of the maximum Barkhausen noise amplitude M_{MAX}(σ) for a test piece after the first hardening and cooling has a maximum,
d) further hardening of the test piece up to Ostwald ripening,
e) determination of the load stress value σ₃ at which the load stress dependency of the maximum Barkhausen noise amplitude M_{MAX}(σ) for a test piece after further hardening up to Ostwald ripening and cooling has a maximum,
f) determination of the internal microstress of type II (σ_{therm·II}) as difference σ_{therm·II}=|σ₁−σ₃|
g) determination of the internal microstress of type III by
   i. formation of the sum of the internal microstress of type II and of the internal microstress of type III as difference

Δσ=σ_{therm·II}+σ_{coh·III}=|σ₁−σ₂|
and subsequent subtraction

σ_{coh·III}=|Δσ−σ_{therm·II}
or
ii. as difference

σ_{coh·III}=σ₃−σ₂|

The method according to the invention is based on the knowledge that, during the first hardening of the test piece up to exclusive formation of coherent Cu precipitations, internal microstress of type II is built up whilst, during subsequent hardening of the test piece up to Ostwald ripening, internal microstress of type III is reduced. The maximum of the Barkhausen noise amplitude M_{MAX} is dependent upon the external load stress. This load stress dependency of the maximum Barkhausen noise amplitude, the so-called M_{MAX}(σ) curve, has a maximum. By comparing the position of the maximum of the M_{MAX}(σ) curve before or after specific thermal hardening states, a conclusion can be drawn with respect to the internal microstress of type II and/or III.

The terms and terminologies used according to the invention are thereby understood as follows:

### Maximum of the Barkhausen Noise Amplitude:

During magnetic reversal, lattice inhomogeneities impede Bloch wall movements, the result, during the actually reversible displacement of the Bloch walls, is again and again to stop the movement of energy barriers which are overcome only with an increase in the external field and hence in the driving force of the magnetic reversal process in a surge, by means of so-called Barkhausen jumps of the Bloch walls. These jump processes are irreversible, i.e. they are the basis for energy dissipation during magnetisation.

A sudden magnetic reversal of a small material region accompanies a Barkhausen jump. This causes a rapid flux density change of the magnetic field which, for its part, induces eddy currents in the surrounding material. The eddy currents in turn lead to flux density changes in the volume regions surrounding them.

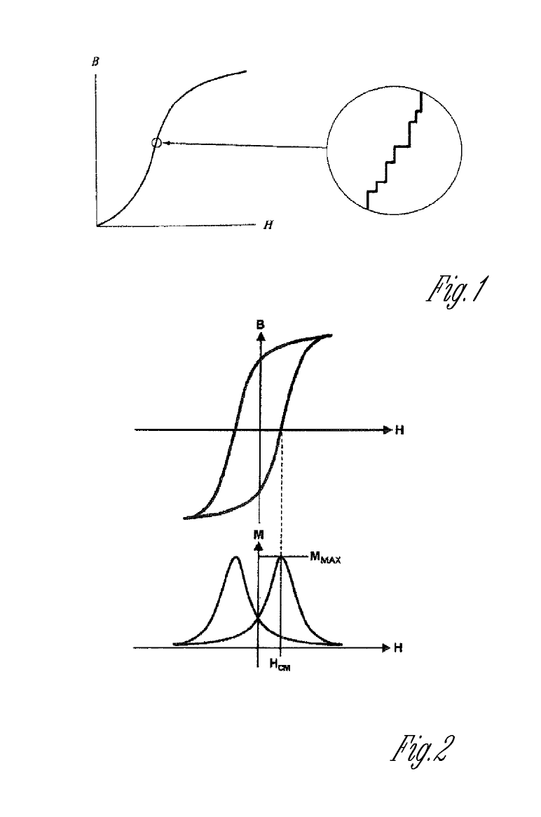

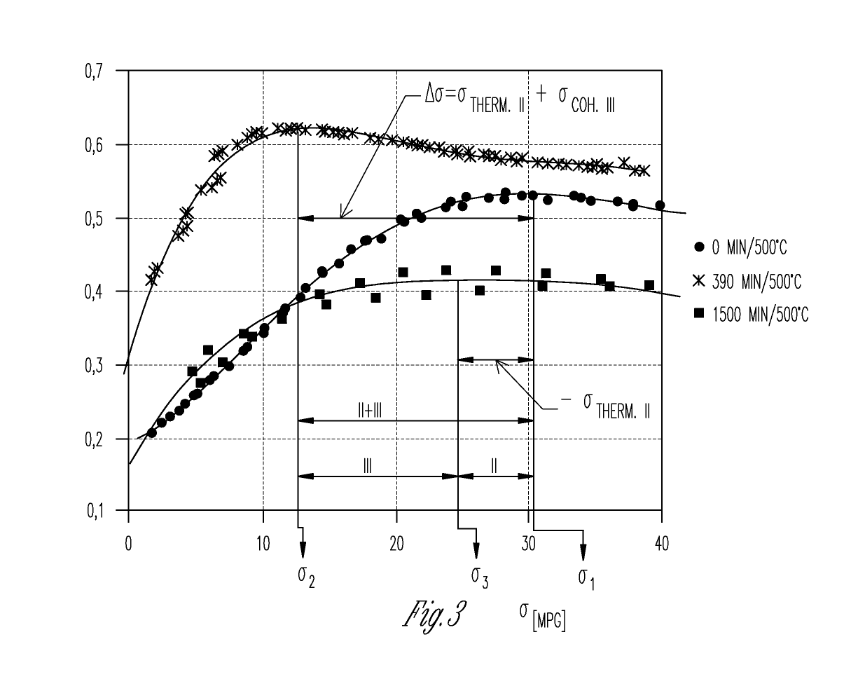

The eddy currents diffuse towards the material surface where they can be detected with the help of a coil as voltage pulses. Since these voltage pulses can be heard in a loudspeaker as crackling or hissing, this is described as Barkhausen noise. This hereby concerns a stochastic process. The macroscopically measured magnetisation process of a sample is composed of many small jumps so that the hysteresis consists of many small steps (cf. FIG. 1). In the steepest region of the hysteresis, near the coercive field strength H_{c} 180° wall displacement processes dominate the magnetic reversal process. Therefore, in full control of this region, also most jump processes can be observed. FIG. 2 shows a Barkhausen noise profile curve. The “noise activity” M which is derived from the sensor signals is hereby represented as a function of the magnetic tangential field strength H. As expected, the Barkhausen noise profile curve has a maximum at a field strength value near the coercive field strength H.

The Barkhausen noise profile curve can be obtained experimentally as follows:
1. Measurement of the temporal course of the magnetic tangential field strength H and of the flux density change

$$\frac{d ∅}{d t} ,$$

this is thereby always measured in the same direction of the flux density change, i.e. either with increasing or decreasing flux density.
2. High-pass filtering of the temporal signal of the flux density change in order to separate the stochastic signal components of the Barkhausen jumps from the residual signal.
3. Rectification of the filtered signal with subsequent low-pass filtering in order to form the envelope. The resulting signal is designated as M.
4. In order to form the Barkhausen noise profile curve, the rectified signal M is plotted over the measured temporal signal of the tangential field strength H. This profile curve has a maximum, designated M_{MAX}.

A detailed procedural rule for determining the maximum of the Barkhausen noise amplitude which is also applied within the scope of the present application, is described in I. Altpeter et al., NDT&E International 42 (2009), 283-290. With respect to the method for determining the maximum of the Barkhausen noise amplitude, reference is made in this respect to the previously cited article, the disclosure content of which in its entirety is also made the subject of the present application.

### Ostwald Ripening:

In the case of Ostwald ripening of precipitation-capable alloy systems, the average particle diameter and the particle spacing of already precipitated crystalline domains is increased, whilst the precipitated volume component of these domains remains constant. This becomes possible by larger particles consuming smaller ones so that the larger particles become coarse. Since the particles themselves cannot migrate, these processes are dominated by atomic diffusion.

### Hardening Progression:

In every temporal hardening progression of precipitation-capable alloys, the conversion of coherent via partially coherent into incoherent precipitations is reflected during the thermal hardening. A typical hardening progression is distinguished by an upward branch in which an alloy with mainly coherent precipitations is present, a hardness maximum in which partially coherent precipitations predominate and a downward branch in which incoherent precipitations are present and take place in the Ostwald ripening process.

### Hardening:

According to the invention, there is understood by the term “hardening”, thermal hardening. In the case of thermal hardening, a heat treatment is implemented in order to increase the hardness and strength of the test piece. In the case of hardening, the precipitation of metastable phases in a finely distributed form takes place so that these represent an effective barrier for displacement movements of the test piece, as a result of which the increase in hardness is explained. In the case of hardening, a precipitation hardening hence takes place.

In the above-mentioned steps a), c) and/or e) of the method according to the invention, a recording of the Barkhausen noise amplitude curves is hence effected and also determination of the maxima of the load stress dependency (M_{MAX}(σ)), the applied mechanical load stress on the test piece respectively being plotted against the obtained maximum value of the Barkhausen noise amplitude M_{MAX}. Hence a mechanical load stress is applied to the test piece, kept constant and the maximum value of the Barkhausen noise amplitude is determined. This measurement is repeated with different external mechanical load stresses. A mechanical load stress can thereby be a tensile load stress but also a compressive load stress, which is applied to the test piece with external mechanical means. If the maximum of the Barkhausen noise profile curve M_{MAX} is recorded as a function of an applied load stress σ, typically the so-called M_{MAX}(σ) curve results. This curve in turn passes through a maximum which represents the maximum load stress dependency of the maximum value of the Barkhausen noise amplitude. The internal microstresses of type II or III can respectively be indicated as a value of the differential stress between two sample states.

In the case of the above-indicated method according to the invention, in a first step there is effected the determination of the maximum value of the Barkhausen noise amplitude M_{MAX} as a function of a variable external load stress σ of a test piece (the so-called M_{MAX}(σ) curve) which is formed from the alloy system. The test piece is thereby present in an initial state. As initial state, a solution-annealed and quenched, however not yet thermally hardened, piece can thereby be used. After determining the maximum of the so-called M_{MAX}(σ) curve, a tensile load stress σ₁ which correlates with the maximum of the Barkhausen noise amplitude is produced.

Subsequently, a first hardening of the test piece up to exclusive formation of coherent Cu precipitations is effected. It is crucial in this step that still no, or only to a subordinate degree, partially and/or incoherent Cu precipitations have been formed. The formation of coherent precipitations can be followed during this hardening step by means of testing the hardness of the test piece. As long as the hardness is still increasing during the previously mentioned thermal hardening, no, or merely to a subordinate degree, partially- and/or incoherent Cu precipitations occur. The first hardening step should therefore be implemented preferably such that an increase in hardness of the test piece is achieved but the theoretical hardness maximum which can be achieved during thermal hardening is not achieved. Reaching this state can be determined by simple experiments (e.g. determining the Vickers hardness on hardness test samples).

The hardness maximum can be determined from the progression of the determined Vickers hardness as a function of the hardening duration. The hardness value at which mainly coherent Cu precipitations are present in the Fe matrix can be chosen for example less than the hardness maximum by 10 HV5.

The procedure in the first hardening is thereby based on the discoveries of Ogi et al. (“Snoek relaxation in a Copper-precipitated alloy steel”, Journal of Alloys and Compounds, 310 (2000), 432 to 435), according to which an increase in hardness can be observed with thermal ageing of Cu—Fe alloys.

Hardening durations at 500° C. for achieving the first hardening state, which are produced by way of example within the scope of the present invention, are indicated in the subsequent table, by way of example. The samples used thereby were binary iron-copper alloys, short hardening durations resulting with an increasing copper content. In the case of the indicated hardening durations, merely coherent copper precipitation states were obtained.

TABLE 1
hardening duration for adjusting small, coherent Cu precipitation states

| | % by weight of Cu | | | | | | | | | |
|---|---|---|---|---|---|---|---|---|---|---|
| | 0.5 | 0.65 | 0.75 | 0.9 | 1.0 | 1.2 | 1.4 | 1.5 | 1.7 | 1.9 |
| Hardening | 35 | 14 | 10 | 7.83 | 6.5 | 4.5 | 3.5 | 3 | 1.5 | 1.17 |
| duration at | | | | | | | | | | |
| 500° C. [h] | | | | | | | | | | |

The thus hardened test piece is again subjected to determination of the M_{MAX}(σ) curve. This determination is effected analogously to the determination of the M_{MAX}(σ) curve in the first step. A second load stress σ₂ is obtained at which the now recorded M_{MAX}(σ) curve has a maximum.

Subsequently a further hardening of the test piece up to Ostwald ripening is effected so that the conditions which were already given earlier are fulfilled.

Finally, a further recording of the M_{MAX}(σ) curve is effected. The maximum of this recorded curve is assigned to a third load stress σ₃.

The internal microstresses of type II and III can be derived from the obtained load stresses σ₁, σ₂ and σ₃.

The internal microstress of type II is thereby determined as the difference σ_{therm·II}=|σ₁−σ₃|.

The internal microstress of type III can be determined in addition as the difference σ_{coh·III}=|Δσ−σ_{therm·II}|, there applying for the difference Δσ: Δσ=σ_{therm·II}+σ_{coh·III}=|σ₁−σ₂|.

Alternatively, determination of the internal microstress of type III is possible as the difference of the above-determined values σ₂ and σ₃:

σ_{coh·III}=|σ₃−σ₂|.

The method described above therefore requires merely two hardening processes and also threefold recording of M_{MAX}(σ) curves in order to be able to determine both the internal microstress of type II and type III.

The particular advantage of the two previously described methods according to the invention is thereby that the methods take place in an easily implementable, reproducible and also non-destructive manner. In addition, no reference methods are required.

The most important advantage of the testing method according to the invention resides in the fact that it allows a non-destructive and quantitative determination of internal microstresses of type II and III and also a separation of these two internal microstresses.

The developed testing method approach enables for example online monitoring of the internal microstress changes of components (e.g. reactor pressure containers, pipelines made of steels based on Fe—Cu systems).

In the case of the method according to the invention for determining the microstress of type III and/or II, it is thereby preferred if the first hardening of the test piece is effected by solution-annealing of the test piece, quenching of the test piece and also heat treatment of the test piece.

In addition, it is preferred if
a) the solution-annealing of the test piece is effected at temperatures between 700 and 911° C., preferably between 750 and 905° C., in particular between 800 and 860° C. and/or over a time period of 30 min to 24 hours, preferably of 30 min to 5 hours, in particular of 1 to 3 hours,
b) the quenching is effected by immersing the test piece in a fluid, in particular water,
   and/or
c) the heat treatment is effected by a one- or multi-step storage of the test piece at temperatures between 250 and 750° C., preferably between 300 and 600° C., in particular between 350 and 550° C. and/or over a time period of up to 14 hours, preferably of 5 hours to 14 hours.

In the case of the method according to the invention, it is furthermore advantageous if the further hardening of the test piece up to Ostwald ripening is effected by thermal overageing of the test piece in the multiphase region.

The thermal overageing is effected preferably by a one- or multi-step storage of the test piece at temperatures between 250 and 750° C., preferably between 300 and 600° C., in particular between 350 and 550° C. and/or over a time period of 14 hours to 108 hours.

Since the thermal ageing and overageing take place with diffusion control, the times and temperatures in these processes depend upon the Cu content of the alloy.

According to the invention, a method for non-destructive quantitative determination of the internal microstress of type II is likewise indicated, which is likewise based on the previously recognised principles. According to this method which can be implemented on an Fe- and Cu-containing alloy system with a Cu content ≦2% by weight, the following steps are implemented:
a) determination of the load stress value σ₁ at which the load stress dependency of the maximum Barkhausen noise amplitude M_{MAX}(σ) for a test piece made of the alloy system in an initial state has a maximum,
b) hardening of the test piece up to Ostwald ripening,
c) determination of the load stress value σ₃ at which the load stress dependency of the maximum Barkhausen noise amplitude M_{MAX}(σ) for a test piece after hardening up to Ostwald ripening and cooling has a maximum value, and also
d) determination of the internal microstress of type II as difference σ_{therm·II}=|σ₁−σ₃|.

Determination of the load stress values σ₁ and σ₃ in the initial state or in the hardened state (up to Ostwald ripening) is thereby effected according to the above-described principles.

In the case of hardening of the test piece up to Ostwald ripening, starting from the initial state, a thermal hardening is implemented which transfers the test piece from the initial state into the state of Ostwald ripening.

In a preferred embodiment, the hardening of the test piece up to Ostwald ripening is effected by heat treatment, in which a solution-annealing of the test piece, quenching of the test piece and also thermal overageing of the test piece up to Ostwald ripening is implemented.

For example, the solution-annealing of the test piece can be implemented at temperatures between 700 and 911° C., preferably between 750 and 905° C., in particular between 800 and 860° C. and/or over a time period of 30 min to 24 hours, preferably of 30 min to 5 hours, in particular of 1 to 3 hours. The choice of temperature and/or of the time period can thereby be chosen according to the copper content of the alloy systems.

The quenching of the test piece is effected preferably by immersing the test piece in a fluid, in particular water.

The thermal overageing is effected preferably by a one- or multi-step storage of the test piece at temperatures between 250 and 750° C., preferably between 300 and 700° C., in particular between 350 and 550° C. and/or over a time period of up to 108 hours, preferably of 5 hours to 108 hours.

Furthermore, the present invention likewise makes available a method for non-destructive quantitative determination of the internal microstress of type III (coherency tensile internal stress of type III) of an Fe- and Cu-containing alloy system, with a Cu content ≦2% by weight, comprising the following steps:
a) first hardening of the test piece up to exclusive formation of coherent Cu precipitations,
b) determination of the load stress value σ₂ at which the load stress dependency of the maximum value of the Barkhausen noise amplitude M_{MAX}(σ) for a test piece after the first hardening and cooling has a maximum,
c) further hardening of the test piece up to Ostwald ripening,
d) determination of the load stress value σ₃ at which the load stress dependency of the Barkhausen noise amplitude M_{MAX}(σ) for a test piece after further hardening up to Ostwald ripening and cooling has a maximum, and also
e) determination of the internal microstress of type III as difference σ_{coh·III}=|σ₃−σ₂|.

This method is implemented essentially like the previously described method (the method according to claim 1), however determination of the maximum value of the load stress dependency of the maximum value of the Barkhausen noise amplitude in the initial state of the test piece is hereby unnecessary.

For all previously described aspects of the present invention, i.e. both for the method for simultaneous determination of internal microstresses of type II and III and for the methods with which merely the internal microstresses of type II or III can be determined, the subsequently preferred embodiments apply:

Preferred, useable alloy systems for the test piece are thereby selected from the group consisting of Fe—Cu—, Fe—Cu—Ni— or Fe—Cu—Ni—Mn alloys. The alloys are thereby capable of precipitation, i.e. Cu can be precipitated during thermal treatment of the alloys.

For all previously mentioned alloy systems, it is preferred if the Cu minimum content is 0.1% by weight, preferably 0.3% by weight.

In the case where an Fe—Cu alloy is used, it is preferred if this has a Cu content of 0.1 to 2% by weight, preferably of 0.3 to 2% by weight, in particular of 0.6 to 2% by weight.

Preferred Fe—Cu—Ni alloy systems thereby have a Cu content of 0.1 to 5% by weight, preferably of 0.3 to 3% by weight, in particular of 0.6 to 2% by weight;

and also an Ni content of 0.1 to 10% by weight, preferably of 0.5 to 5% by weight, in particular of 0.8 to 2% by weight.

The invention can likewise be used with Fe—Cu—Ni—Mn alloy systems which advantageously have a Cu content of 0.1 to 5% by weight, preferably of 0.3 to 3% by weight, in particular of 0.6 to 2% by weight; an Ni content of 0.1 to 10% by weight, preferably of 0.5 to 5% by weight, in particular of 0.8 to 2% by weight; and also an Mn content of 0.1 to 8% by weight, preferably of 0.3 to 5% by weight, in particular of 0.5 to 1.3% by weight.

In the case of the previously mentioned alloy systems given by way of example, the individual components respectively can be chosen independently of the other components. The iron matrix is thereby present in addition to the mentioned components so that the result is 100% by weight.

In the case of the methods according to the invention, it is preferred if the maximum load stress applied to the test piece is at most 50% of the yield point of the material of the test piece.

In addition, it is advantageous if the load stress σ, applied to the test piece, is varied from 0.01 to 100 MPa, preferably from 0.1 to 50 MPa.

In particular, tensile load stresses are applied to the test piece.

The present invention is explained in more detail with reference to the subsequent embodiments and Figures without restricting the invention to the illustrated parameters.

The method according to the invention is explained in more detail subsequently with reference to the example of a method for determining the internal microstresses of type III with simultaneous determination of the internal microstress of type II.

The embodiments can however be transferred analogously to the embodiment which is likewise according to the invention and in which merely determination of the internal microstress of type II or III is effected.

The test method according to the invention requires the recording of M_{MAX}(σ) curves for three heat treatment states: the initial state (quenched, not yet hardened), the state hardened up to the hardness maximum and also the state hardened up to the area of Ostwald ripening.

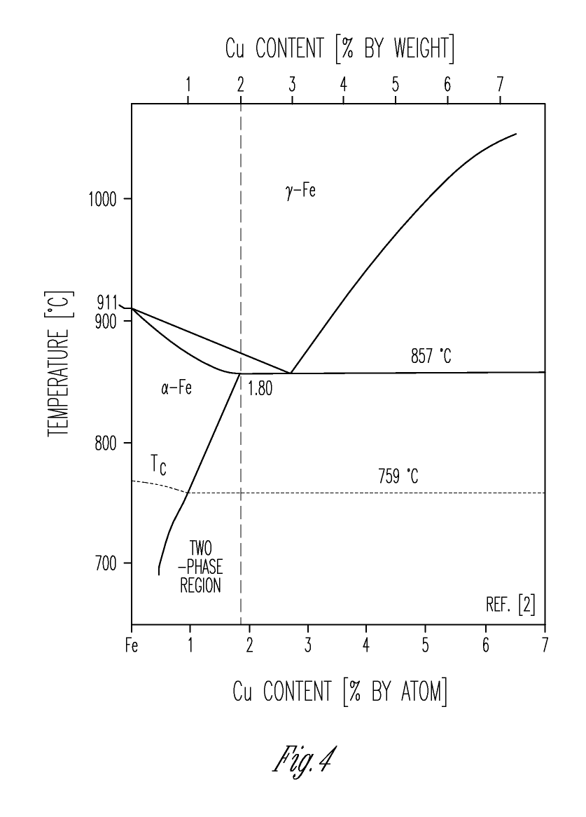

FIG. 3 shows the maximum load stress dependency of the maximum Barkhausen noise amplitude (M_{MAX}(σ) curves) as a function of tensile load stresses for these three heat treatment states by way of example for an Fe—Cu alloy with 1.0% by weight of Cu. These M_{MAX}(σ) curves differ by the position of their maximum on the tensile load stress axis. With respect to the maximum displacements of the M_{MAX}(σ) curves, the following observations were made within the scope of earlier works (cf. I. Altpeter et al. (NDT&E International 42 (2009), 283-290)): compressive internal stresses, in comparison with the initial state, lead to a displacement of the maximum towards higher tensile load stress values, whilst tensile internal stresses effect a displacement of the maximum towards lower tensile load stress values. Hence the change in the internal stress state is characterised directly via the maximum displacement.

The above-mentioned initial state, in the case of Fe—Cu alloys, is the quenched, unhardened state. This state is characterised by the compressive internal stresses of type I which are thermally induced during quenching (FIG. 3—0 min)

During hardening of the Fe—Cu samples, two opposing processes take place. At the beginning of the hardening, the quenching compressive internal stresses (thermally induced internal stresses of type I) which are produced by the sample production are reduced. With increasing hardening time, the so-called coherency tensile internal stresses of type III originating from the Cu precipitations in the α—Fe matrix increase. As a result of cooling after the hardening, additional thermally induced compressive internal stresses of type I and II are produced. The peak displacement between the initial state and the state hardened at 500° C. for 390 minutes corresponds to an internal stress change of Δσ=σ_{therm·II}+σ_{coh·III}. In order to be able to determine the coherency tensile internal stresses of type III, preferably the following procedure can be implemented.
Step 1) Recording the M_{MAX}(σ) curves of the initial state after quenching and determining the position of the maximum at σ₁.
Step 2) Recording the M_{MAX}(σ) curve after a hardening time of 390 minutes at 500° C., subsequent cooling and determining the position of the maximum at σ₂. This hardening time was chosen, starting from the hardness- and SANS measurements such that exclusively coherent Cu precipitations are present in the iron matrix (FIG. 3—390 min). This state is characterised by thermally induced compressive internal stresses of type I, thermally induced compressive internal stresses of type II and coherency tensile internal stresses of type III. The displacement Δσ of the maximum of the M_{MAX}(σ) curve between the quenched, not yet hardened state and the hardened quenched state is Δσ=σ_{therm·II}+σ_{coh. III}=17 MPa. This relatively small value can be attributed to a sum of the thermally induced compressive internal microstresses of type II and the coherency tensile internal stresses of type III. In order to be able to determine the coherency tensile internal stresses of type III, the thermally induced compressive internal microstresses of type II must be known.
Step 3) Recording the M_{MAX}(σ) curve after hardening in the area of the Ostwald ripening (after 1,500 min at 500° C.) and subsequent cooling (FIG. 31—1,500 min) and determining the position of the maximum at σ₃. This state is characterised by thermally induced compressive internal stresses of type I and thermally induced compressive internal stresses of type II since the Cu precipitations become incoherent due to the Ostwald ripening and hence coherency tensile internal stresses are no longer present. The displacement of the maximum of the M_{MAX}(σ) curve between the quenched, not yet hardened state and the Ostwald ripened, quenched state corresponds to the thermally induced compressive internal stresses of type II and is 5 MPa.
Step 4) Determining the coherency tensile internal stresses of type III by subtracting the thermally induced internal stresses of type II from the sum Δσ=σ_{therm·II}+σ_{coh·III}. For the alloy shown in FIG. 3, this means a coherency tensile internal stress value of 22 MPa.

The preferred alloys on which the internal microstresses of type II and III can be determined non-destructively by means of this method are Fe—Cu alloys which are capable of precipitation. Fe—Cu alloys which are capable of precipitation, by way of example, preferably comprise at most 2.0% by weight of Cu and the remainder Fe. Within the scope of the invention according to the invention, Fe—Cu alloys with 0.65, 0.75, 0.9, 1.0, 1.2, 1.4, 1.5, 1.7 and 1.9% by weight of Cu were produced and investigated.

Further preferred alloys on which the internal microstresses of type II and III can be determined non-destructively by means of this method are Fe—Cu—Ni—Mn alloys which are capable of precipitation. The investigated Fe—Cu—Ni—Mn alloys comprise 0.65% by weight of Cu, 1.0% by weight of Ni with respectively 0.75, 0.95, 1.15 and 1.3% by weight of Mn and also 1.3% by weight of Ni with respectively 0.75, 0.95, 1.15 and 1.3% by weight of Mn.

The Fe—Cu alloys, in the single-phase region (FIG. 4), are solution-annealed at 850° C. for 2 hours, quenched in water and subsequently hardened thermally in the two-phase region (below the solubility line, see FIG. 4) at 500° C. for up to 1,500 minutes. In order to produce samples with a graduated volume component of coherent Cu precipitations, they were hardened for different lengths of time as a function of the Cu content. In every hardening progression, the conversion of coherent via partially coherent into incoherent precipitations during the hardening is reflected. A typical hardening progression is distinguished by an upward branch in which an alloy with mainly coherent precipitations is present, a hardness maximum in which partially coherent precipitations predominate and a downward branch in which incoherent precipitations are present and in which Oswald ripening processes take place. In order to determine the hardening time which is sufficient for adjustment of coherent Cu precipitations, firstly test samples were produced. Hardness measurements (according to Vickers DIN EN ISO 6507-4:2005) were implemented on these test samples at 500° C. in temporal steps of different lengths as a function of the Cu content. This experiment was implemented until the hardness maximum was achieved. In order to produce alloys with coherent precipitations, the hardening durations should be chosen as a function of the respective Cu content below the heat treatment duration which corresponds to the respective hardness maximum. In this way the necessary hardening duration for adjusting exclusively small (1-1.5 nm radius) coherent precipitation states was determined (Table 2). In a first hardening step, precipitations with average radii of approx. 1 nm were adjusted and, in a second hardening step, precipitations with average radii of approx. 1.5 nm. The small-angle neutron scattering (SANS) investigations have shown that the produced samples have Cu precipitations with a radius of less than 5 nm. It can be concluded herefrom that in fact coherent Cu precipitations are present in the Fe—Cu alloys. It was hence demonstrated that the chosen hardening times are sufficient for adjusting small (1-1.5 nm radius see Table 3) coherent Cu precipitations.

TABLE 2
Hardening duration for adjusting coherent Cu precipitations

| | % by weight of Cu | | | | | | | | | |
|---|---|---|---|---|---|---|---|---|---|---|
| | 0.5 | 0.65 | 0.75 | 0.9 | 1.0 | 1.2 | 1.4 | 1.5 | 1.7 | 1.9 |
| Hardening | 35 | 14 | 10 | 7.83 | 6.5 | 4.5 | 3.5 | 3 | 1.5 | 1.17 |
| duration [h] | | | | | | | | | | |

TABLE 3
Measurement results derived from the SANS investigations

| Cu | | | |
|---|---|---|---|
| content | Cu precipitation | Proportion of precipitated Cu | |
| [% by | radius | particles | Density |
| weight] | [nm] | [% by vol.] | [cm⁻³] |
| 0.65 | 0.81 | 0.112 | 2.27 × 10¹⁷ |
| 1.0 | 0.81 | 0.347 | 9.35 × 10¹⁷ |
| 1.4 | 1.17 | 0.729 | 9.26 × 10¹⁷ |
| 1.7 | 1.06 | 0.676 | 1.34 × 10¹⁸ |

Subsequently, the samples were thermally overaged (thermally hardened until in the region of the Oswald ripening). In the stage of Oswald ripening, the precipitated volume component remains constant, whilst the average particle diameter and the particle spacing increase. This is made possible by smaller particles being consumed by larger ones so that the larger particles become coarse. Since the particles themselves cannot migrate, also these processes are controlled by atomic diffusion.

The Fe—Cu—Ni—Mn alloys, for example in the single-phase region (FIG. 4), are solution-annealed at 850° C. for 2 hours, quenched in water and subsequently thermally hardened in the two-phase region (below the solubility line) at 500° C. for 12 hours and thereafter at 360° C. for up to 181 days.

These hardening times were calculated by means of simulation calculations such that the alloys comprise nanoscale Cu precipitations, enveloped by an Ni—Mn shell (as in the Cu-containing beams).

In the case of the Fe—Cu—Ni—Mn alloys, the change in the internal microstress state was likewise characterised by measurement of the M_{MAX}(σ) curves of different hardening states.

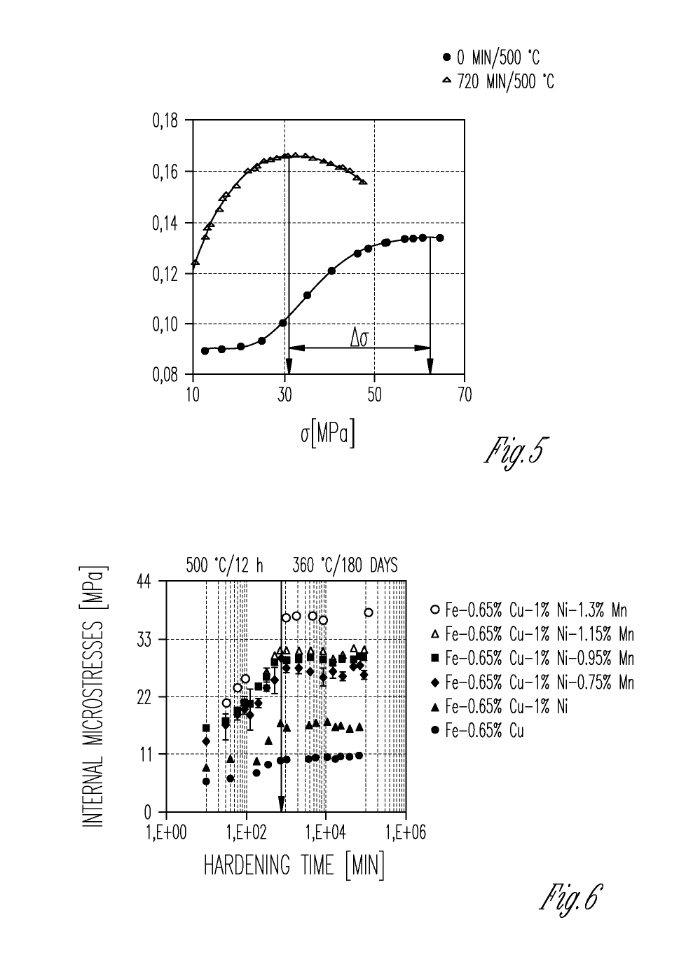

FIG. 5 shows the M_{MAX}(σ) curve for the Fe-0.65% by weight-Cu-1.0% by weight-Ni-0.75% by weight-Mn alloy in the initial state and in the finally hardened state (Oswald ripening). In the case of these Fe—Cu—Ni—Mn alloys, there was measured, after completion of the hardening, a displacement of the maximum of the M_{MAX}(σ) curves towards smaller tensile load stress values. This indicates an increase in the internal microstresses of type II and III up to 40 MPa, induced as a result of the hardening, since these samples were hardened such that exclusively coherent precipitations are produced.

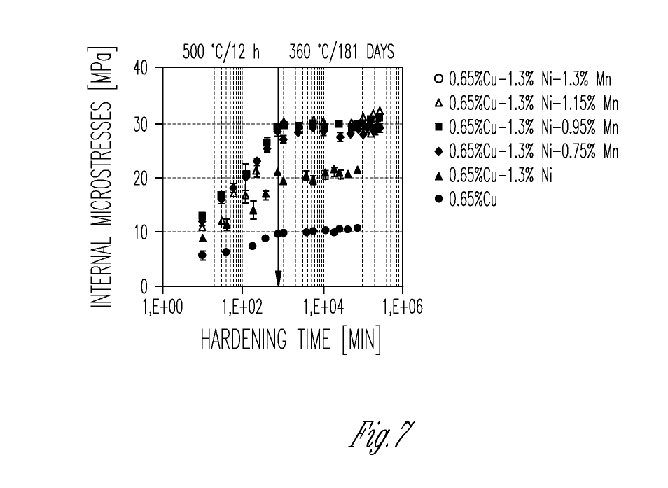

FIG. 6 shows the progression of the internal microstress values (Δσ) derived from the M_{MAX}(σ) curves as a function of the hardening duration. It was established that, in the case of the samples with 1.0% by weight of Ni, an increase in the Mn content leads to an increase in the internal microstresses although the Cu content remains constant. It can be observed in FIG. 7 that merely the alloying of Ni causes an increase of up to 18 MPa. Additional alloying of Mn leads to a further increase in the internal microstresses up to 40 MPa.

In addition to the experimental investigations, atomic Monte-Carlo (MC) simulations for forming and growing precipitations were implemented and also molecular dynamic (MD) simulations for determining the internal stresses in the above-mentioned alloys. For the MC simulations, an improved energy approach, which is suitable in practice, was used, based on quantum-mechanical ab-initio calculations. The MC simulations provide the average radii, the number density and the chemical composition of the precipitations with different Ni and Mn contents and also with different temperature treatments. In additional MC simulations, it was shown that both Ni and Mn increase the number density of the precipitations.

For the MD simulations, a new Fe—Cu—Ni-EAM (Embedded Atom Method) potential, published in 2009, was implemented and used and also an evaluation program was developed for determining the local and also the global stresses. The MD simulations show that very high local stresses up to 3,000 MPa occur at Fe/Cu interfaces and drop significantly in the interior of the Cu precipitation. For the Fe—Cu— and Fe—Cu—Ni precipitation states obtained from the MC simulations, MD simulations (relaxations, subsequent number pressure temperature ensemble) for different temperatures were implemented and the global internal stresses for each type of atom were calculated. Herewith, a differentiation between coherency- and thermally induced internal stresses is made possible. From the MD simulations, tensile internal stresses in the Fe matrix, with an increasing Mn proportion, up to 40 MPa which are caused by the precipitations are produced for the samples with 0.65% by weight of Cu, 1.0% by weight of Ni and different Mn contents. The simulations accord well with the experiments implemented on the INDT.

Even for the samples with 0.65% by weight of Cu, 1.3% by weight of Ni and different Mn contents, good correspondences resulted between experimental and simulation results with respect to the internal microstresses (see in this respect Table 4 and FIG. 7).

TABLE 4
Comparison between experimental and simulation results, Δσ is
respectively the difference between precipitation state and
mixed crystal

| | | | 12 h, 500° C., then | |
|---|---|---|---|---|
| | 12 h, 500° C. | | 180 days, 360° C. | |
| | Δσ [MPa] | | Δσ [MPa] | |
| | Experi- | Simul- | Experi- | Simul- |
| | ment | ation | ment | ation |
| Fe—0.65% by weight of Cu | 10 | 18 | 11 | 18 |
| Fe—0.65% by weight of | 21 | 19 | 22 | 22 |
| Cu—1.30% by weight of Ni | | | | |
| Fe—0.65% by weight of | 28 | 25 | 29 | 32 |
| Cu—1.30% | | | | |
| by weight of Ni—0.75% | | | | |
| by weight of Mn | | | | |
| Fe—0.65% by weight of | 29 | 26 | 31 | 36 |
| Cu—1.30% | | | | |
| by weight of Ni—0.95% | | | | |
| by weight of Mn | | | | |
| Fe—0.65% by weight of | 29 | 27 | 28 | 38 |
| Cu—1.30% | | | | |
| by weight of Ni—1.15% | | | | |
| by weight of Mn | | | | |
| Fe—0.65% by weight of | 21 | 29 | 19 | 18 |
| Cu—1.30% | | | | |
| by weight of Ni—1.30% | | | | |
| by weight of Mn | | | | |

What is claimed is:

1. A method for non-destructive quantitative determination of the internal microstress of type III (coherency tensile internal stress of type III, σ_{coh·III}) and of type II (thermally induced internal stress of type II, σ_{therm·II}) and/or of the sum of the internal microstresses of type II and III (Δσ=σ_{therm·II}+σ_{coh·III}) of an Fe- and Cu-containing alloy system with a Cu content of ≦2% by weight, the method comprising:
a) determination of the load stress value σ₁ at which the load stress dependency of the maximum Barkhausen noise amplitude M_{MAX}(σ) for a test piece made of the alloy system in an initial state has a maximum,
b) first hardening of the test piece up to exclusive formation of coherent precipitations,
c) determination of the load stress value σ₂ at which the load stress dependency of the maximum Barkhausen noise amplitude M_{MAX}(σ) for a test piece after the first hardening and cooling has a maximum,
d) further hardening of the test piece up to Ostwald ripening,
e) determination of the load stress value σ₃ at which the load stress dependency of the maximum Barkhausen noise amplitude M_{MAX}(σ) for a test piece after further hardening up to Ostwald ripening and cooling has a maximum,
f) determination of the internal microstress of type II (σ_{therm·II}) as difference σ_{therm·II}=|σ₁−σ₃|, and
g) determination of the internal microstress of type III by
i. formation of the sum of the internal microstress of type II and of the internal microstress of tune III as difference
Δσ=σ_{therm·II}+σ_{coh·III}=|σ₁−σ₂|

and subsequent subtraction
σ_{coh·III}=|Δσ−σ_{therm·II}|

or
ii. as difference
σ_{coh·III}=σ₃−σ₂|.

2. The method according to claim 1, wherein the first hardening of the test piece is effected by solution-annealing of the test piece, quenching of the test piece and also heat treatment of the test piece.

3. The method according to claim 1, wherein
a) the solution-annealing of the test piece is effected at temperatures between 700 and 911° C., preferably between 750 and 905° C., in particular between 800 and 860° C. and/or over a time period of 30 min to 24 hours, preferably of 30 min to 5 hours, in particular of 1 to 3 hours,
b) the quenching is effected by immersing the test piece in a fluid, in particular water, and/or
c) the heat treatment is effected by a one- or multi-step storage of the test piece at temperatures between 250 and 750° C., preferably between 300 and 600° C., in particular between 350 and 550° C. and/or over a time period of up to 14 hours, preferably of 5 hours to 14 hours.

4. The method according to claim 1, wherein the further hardening of the test piece up to Ostwald ripening is effected by thermal overageing of the test piece in the multiphase region.

5. The method according to claim 4, wherein the thermal overageing is effected by a one- or multi-step storage of the test piece at temperatures between 250 and 750° C., preferably between 300 and 600° C., in particular between 350 and 550° C. and/or over a time period of 14 hours to 108 hours.

6. A method for non-destructive quantitative determination of the internal microstress of type II (thermally induced internal stress of type II) of an Fe- and Cu-containing alloy system with a Cu content 2% by weight, the method comprising:
a) determination of the load stress value σ₁ at which the load stress dependency of the maximum Barkhausen noise amplitude M_{MAX}(σ) for a test piece made of the alloy system in an initial state has a maximum,
b) hardening of the test piece up to Ostwald ripening,
c) determination of the load stress value σ₃ at which the load stress dependency of the maximum Barkhausen noise amplitude M_{MAX}(σ) for a test piece after hardening up to Ostwald ripening and cooling has a maximum value, and
d) determination of the internal microstress of type II as difference σ_{therm·II}=|σ₁−σ₃|.

7. The method according to claim 6, wherein the hardening of the test piece up to Ostwald ripening is effected by solution-annealing of the test piece, quenching of the test piece and also thermal overageing of the test piece.

8. The method according to claim 7, wherein the solution-annealing is effected in the solubility region and/or the thermal overageing in the multiphase region.

9. The method according to claim 7, wherein
a) the solution-annealing of the test piece is effected at temperatures between 700 and 911° C., preferably between 750 and 905° C., in particular between 800 and 860° C. and/or over a time period of 10 min to 24 hours, preferably of 30 min to 5 hours, in particular of 1 to 3 hours,
b) the quenching is effected by immersing the test piece in a fluid, in particular water, and/or
c) the thermal overageing is effected by a one- or multi-step storage of the test piece at temperatures between 250 and 750° C., preferably between 300 and 600° C., in particular between 350 and 550° C. and/or over a time period of up to 108 hours, preferably of 5 hours to 108 hours.

10. A method for non-destructive quantitative determination of the internal microstress of type III (coherency tensile internal stress of type III) of an Fe- and Cu-containing alloy system, with a Cu content 2% by weight, the method comprising:
a) first hardening of the test piece up to exclusive formation of coherent Cu precipitations,
b) determination of the load stress value β₂ at which the load stress dependency of the maximum value of the Barkhausen noise amplitude M_{MAX}(σ) for a test piece after the first hardening and cooling has a maximum,
c) further hardening of the test piece up to Ostwald ripening,
d) determination of the load stress value σ₃ at which the load stress dependency of the Barkhausen noise amplitude M_{MAX}(σ) for a test piece after further hardening up to Ostwald ripening and cooling has a maximum, and
e) determination of the internal microstress of type III as difference σ_{coh·III}=|σ₃−σ₂|.

11. The method according to claim 1, wherein the alloy system is selected from the group consisting of Fe—Cu—, Fe—Cu—Ni— or Fe—Cu—Ni—Mn alloys.

12. The method according to claim 11, wherein
a) the Fe—Cu alloy has a Cu content of 0.1 to 5% by weight, preferably of 0.3 to 3% by weight, in particular of 0.6 to 2% by weight,
b) the Fe—Cu—Ni alloy has a Cu content of 0.1 to 5% by weight, preferably of 0.3 to 3% by weight, in particular of 0.6 to 2% by weight; and also an Ni content of 0.1 to 10% by weight, preferably of 0.5 to 5% by weight, in particular of 0.8 to 2% by weight, or
c) the Fe—Cu—Ni—Mn alloy has a Cu content of 0.1 to 5% by weight, preferably of 0.3 to 3% by weight, in particular of 0.6 to 2% by weight; an Ni content of 0.1 to 10% by weight, preferably of 0.5 to 5% by weight, in particular of 0.8 to 2% by weight; and also an Mn content of 0.1 to 8% by weight, preferably of 0.3 to 5% by weight, in particular of 0.5 to 1.3% by weight,
the iron content respectively of the respective alloy adding up to 100% by weight.

13. The method according to claim 1, wherein the maximum load stress applied to the test piece is at most 50% of the yield point of the material of the test piece.

14. The method according to claim 1, wherein the load stress σ, applied to the test piece, is varied from 0.01 to 100 MPa, preferably from 0.1 to 50 MPa.

15. The method according to claim 1, wherein the load stress is a tensile load stress.
